(19) United States
(12) Patent Application Publication
(10) Pub. No.: US 2026/0166354 A1
(43) Pub. Date: Jun. 18, 2026

(54) SYSTEM FOR EXTINGUISHING LITHIUM-ION BATTERY FIRES

(71) Applicant: LoWa Systems, LLC, Mobile, AL (US)

(72) Inventors: John T. Wade, Ocean Springs, MS (US); Bhushan R. Lohar, Mobile, AL (US)

(73) Assignee: LoWa Systems, LLC, Mobile, AL (US)

(21) Appl. No.: 19/409,334

(22) Filed: Dec. 4, 2025

Related U.S. Application Data
(60) Provisional application No. 63/734,867, filed on Dec. 17, 2024.

(51) Int. Cl. A62C 3/16; A62C 3/07; A62C 37/40

(52) U.S. Cl. CPC A62C 3/16; A62C 3/07; A62C 37/40

(57) ABSTRACT

The present disclosure provides a fire extinguishing system for lithium-ion battery fires. The system includes a container configured to enclose a lithium-ion battery, at least two canisters mounted on the container, each canister containing an extinguishing agent, at least one sensor configured to detect indicators of a lithium-ion battery fire, and a computing device operatively connected to the canisters and the sensor. The computing device is configured to trigger discharge of the extinguishing agents from the canisters based on signals from the sensor. The system provides a targeted and automated response to lithium-ion battery fires, enhancing safety in environments where such batteries are used.

### CROSS REFERENCES TO RELATED APPLICATIONS

This application claims priority to U.S. Provisional Application Ser. No. 63/734,867, filed on Dec. 17, 2024, in which application is incorporated herein in its entirety by reference.

### FIELD OF INVENTION

The subject matter of the present disclosure refers generally to fire extinguishing systems configured for extinguishing lithium-ion battery fires.

### BACKGROUND

Lithium-ion batteries have become the dominant energy storage technology across numerous industries and applications, fundamentally transforming how modern society powers portable electronics, electric vehicles, and large-scale energy storage systems. These batteries offer exceptional energy density characteristics that enable compact designs while delivering substantial power output, making them particularly valuable in applications where space and weight constraints are critical factors. The widespread adoption of lithium-ion technology can be attributed to their superior cycle life performance, which allows for thousands of charge-discharge cycles before significant capacity degradation occurs. Additionally, these batteries exhibit relatively low self-discharge rates compared to alternative battery chemistries, enabling extended storage periods without substantial energy loss. Consumer electronics manufacturers have increasingly relied on lithium-ion batteries to power smartphones, tablets, laptops, and wearable devices due to their ability to provide consistent performance throughout extended usage periods. As global demand for electric vehicles continues to accelerate and renewable energy storage requirements expand, the proliferation of lithium-ion battery installations in residential, commercial, and industrial settings has created an unprecedented scale of deployment across diverse environments.

Despite their technological advantages and widespread acceptance, lithium-ion batteries present significant fire safety challenges that distinguish them from conventional combustible materials and traditional battery technologies. These fires exhibit unique characteristics including extremely rapid heat generation rates that can escalate from normal operating temperatures to over 1000° C. within minutes, creating intense thermal conditions that overwhelm standard fire suppression approaches. The phenomenon of thermal runaway in lithium-ion batteries creates a self-sustaining reaction that continues to generate heat and toxic gases even after the initial ignition source has been removed, leading to persistent fire conditions that resist conventional extinguishing methods. Unlike typical fires that depend on ambient oxygen for sustained combustion, many of the exothermic reactions occurring within lithium-ion battery fires proceed independently of external oxygen supply, making traditional smothering techniques largely ineffective. The potential for reignition represents another critical safety concern, as seemingly extinguished battery fires can spontaneously restart hours or even days after the initial incident due to residual heat and ongoing chemical reactions within damaged battery cells. Common triggering factors for these fires include physical damage from impacts or crushing forces, electrical faults such as overcharging or short circuits, manufacturing defects that create internal instabilities, and exposure to extreme temperatures that exceed the battery's safe operating parameters.

A particularly hazardous aspect of lithium-ion battery fires involves the thermal decomposition of lithium hexafluorophosphate (LiPF₆), the most commonly used electrolyte salt in commercial lithium-ion battery systems across consumer electronics, automotive applications, and energy storage installations. When exposed to elevated temperatures during fire events, LiPF6 undergoes spontaneous decomposition into lithium fluoride (LiF) and phosphorus pentafluoride (PF₅), a highly exothermic reaction that significantly increases the heat release rate and accelerates fire propagation throughout the battery pack. The resulting PF₅ compound readily reacts with atmospheric moisture to produce hydrogen fluoride (HF), an extremely corrosive and toxic gas that poses severe health risks to emergency responders and nearby populations. Hydrogen fluoride exposure can cause immediate respiratory distress, severe chemical burns, and long-term health complications including bone deterioration and systemic fluoride poisoning. The corrosive nature of HF also damages firefighting equipment, building materials, and infrastructure, creating additional hazards and complicating emergency response efforts. Research has demonstrated that PF₅ can undergo further decomposition under extreme conditions to produce elemental phosphorus and elemental fluorine, both of which present additional toxicity and reactivity concerns that compound the complexity of lithium-ion battery fire scenarios.

Existing fire suppression methods demonstrate significant limitations when applied to lithium-ion battery fires, particularly those involving LiPF₆ electrolyte systems commonly found in electric vehicles, consumer electronics, and grid-scale energy storage facilities. Traditional water-based suppression systems, while effective for conventional fires, can actually exacerbate lithium-ion battery fire conditions by reacting with lithium metal to produce hydrogen gas and potentially causing explosive conditions. The application of water to these fires also accelerates the hydrolysis of phosphorus pentafluoride, leading to increased production of toxic hydrogen fluoride gas and creating more hazardous conditions for emergency responders. Dry chemical extinguishing agents, including those based on potassium bicarbonate or monoammonium phosphate, provide limited effectiveness against lithium-ion battery fires due to their inability to penetrate battery pack enclosures and reach the source of thermal runaway reactions. These conventional suppressants also fail to address the fundamental problem of ongoing exothermic reactions within damaged battery cells, often resulting in reignition after the initial suppression effort appears successful. Carbon dioxide suppression systems, commonly used in electrical fire scenarios, prove inadequate for lithium-ion battery applications because the oxygen-independent nature of thermal runaway reactions renders smothering techniques ineffective. Furthermore, none of these traditional approaches provide mechanisms for neutralizing or converting the toxic byproducts of lithium-ion battery fires, leaving dangerous concentrations of hydrogen fluoride and other hazardous compounds in the environment long after the visible flames have been extinguished.

The inadequacies of current fire suppression technologies have created an urgent need for specialized systems capable of addressing the unique challenges presented by lithium-ion battery fires in diverse applications ranging from residential settings to large-scale industrial installations. Emergency response protocols for lithium-ion battery fires typically require extensive manual intervention, including prolonged water application periods that can extend for hours or days to ensure complete cooling of battery packs and prevention of reignition. These extended response times place significant strain on emergency services resources and create prolonged exposure risks for first responders who must operate in environments contaminated with toxic gases. Specialized cleaning and decontamination procedures following lithium-ion battery fire incidents often require hazardous materials teams and extensive environmental remediation efforts to address hydrogen fluoride contamination and other toxic residues. The economic impact of these incidents extends beyond immediate fire damage to include costs associated with extended emergency response operations, environmental cleanup, and potential long-term health monitoring for exposed individuals. Current approaches also lack effective containment strategies that prevent the spread of toxic gases to surrounding areas, creating risks for nearby populations and complicating evacuation procedures in densely populated urban environments where lithium-ion battery installations are increasingly common.

Accordingly, there is a need in the art for a system and method specifically designed for extinguishing first resulting from lithium-ion batteries.

### SUMMARY

A system for and method for extinguishing lithium-ion battery fires is provided. In one aspect, the present invention is a system to contain lithium-ion battery fires by isolating them from the surrounding environment with a noncombustible container. In another aspect, the present invention is a system for smothering a lithium-ion fire by generating a non-combustible organohalogens from hydrogen fluoride (or elemental fluorine), a bromine source, and a carbon source. In yet another aspect, the present invention is a system that converts highly toxic hydrogen fluoride from a lithium-ion battery fire into less toxic gases. In still another aspect, the present invention is a method for using the aforementioned systems to extinguish a lithium-ion battery fire. Generally, the present disclosure is a novel lithium-ion battery fire extinguishing system that partially detoxifies the site of the fire through chemical means.

A key driver of lithium-ion battery fires is the spontaneous decomposition of lithium hexafluorophosphate (LiPF₆), a common electrolyte salt in lithium-ion batteries, into lithium fluoride (LiF) and phosphorus pentafluoride (PF₅.) This highly exothermic reaction occurs at high temperatures and increases the heat release rate of the fire further. Exposure to H₂O further hydrolyzes phosphorus pentafluoride to produce hydrogen fluoride (HF); as such, typical firefighting techniques inadvertently contribute to the production of toxic gas, particularly in open areas. Furthermore, as this hydrolysis is itself exothermic, the reaction might offset the cooling sought by spraying water on a fire.

The disclosed system generally comprises at least two cartridges or other chemical repositories incorporated into an enclosure such as a specialized container, garbage receptacle, fireproof blanket, or contained car battery compartment. Upon the occurrence of a lithium-ion battery fire, the repositories discharge their contents onto the fire in order to suppress the decomposition and combustion reactions. This discharge can be automatic and mediated by a heat or hydrofluoric acid sensor sending a signal to a processor. Alternatively, the discharge may be manually activated by a user such as a firefighter, homeowner, or an emergency responder as needed. The extinguishing agents within the repositories operate to both cool the fire and react with the hydrogen fluoride produced by the combustion reaction to produce bromotrifluoromethane (CBrF₃), better known as the potent fire suppression agent Halon 1301, and/or a gas similar to bromotrifluoromethane, such as dibromotetrafluoroethane (C₂Br₂F₃), which is also known as Halon 2402.

The extinguishing agent in each canister generally comprises a carbon source, a bromine source, and water, which operate together to react with HF and/or elemental fluorine produced by the lithium-ion battery fire to produce an organohalogens. Water is not always necessary if the lithium-ion battery fire has already been exposed to moisture such that HF is readily being produced. The bromine source comprises one or more of elemental or aqueous bromine, Br₂ or Br_{2(aq)}. The carbon source preferably comprises chloroform (CHCl₃) or iodoform (CHI₃.) If the carbon source is chloroform, the reaction will proceed via the fluorination of the chloroform with HF to yield trifluoromethane (CHF₃) and hydrogen chloride, which mixes with water to yield hydrochloric acid. CHF₃ is then brominated by the Br₂ to yield organohalogens. Once the fire has been suppressed by cooling and smothering, an optional third wash with a dilute aqueous base such as calcium bicarbonate neutralizes the acids produced by the reaction. Other washes with powdered graphite, carbon nanoparticles, or activated carbon may further help to scavenge or degrade toxic compounds and further cool the lithium-ion battery.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other systems for carrying out the same purpose of the system and method disclosed herein. Those skilled in the pertinent art should also realize that such equivalent designs or modifications do not depart from the scope of the system and method of the present disclosure. For instance, though depicted as a method for suppressing specifically for extinguishing specifically lithium-ion fires, one skilled in the art will recognize the system could also extinguish fires that produce hydrogen fluoride by means other than phosphate pentafluoride decomposition.

Further, it should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF FIGURES

These and other features, aspects, and advantages of the present disclosure will become better understood with regard to the following description, appended claims, and accompanying drawings where:

FIG. 1 illustrates an exterior view of a container-based extinguishing system for lithium-ion battery fires consistent with the principles of the present disclosure.

FIG. 2A illustrates a cross-sectional view of a container-based extinguishing system for lithium-ion battery fires consistent with the principles of the present disclosure.

FIG. 2B illustrates a cross-sectional view of a handheld extinguishing system for lithium-ion battery fires consistent with the principles of the present disclosure

FIG. 3 illustrates a cross-sectional view of a container-based extinguishing system in the process of extinguishing a lithium-ion battery fire in a manner consistent with the principles of the present disclosure.

FIG. 4 illustrates a cross-sectional view of a vehicle-based extinguishing system for lithium-ion battery fires consistent with the principles of the present disclosure.

FIG. 5 illustrates a cross-sectional view of a fireproof blanket-based extinguishing system consistent with the principles of the present disclosure.

FIG. 6 illustrates a flowchart for a method for extinguishing a lithium-ion battery fire using a container-based system.

FIG. 7 illustrates a flowchart for a method for using an integrated fire extinguishing system to extinguish a lithium-ion battery fire in a vehicle.

FIG. 8 illustrates a flowchart for a method for extinguishing a lithium-ion battery fire using a fireproof blanket system.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally. The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components. As defined herein, the word substantial means more than half of the length.

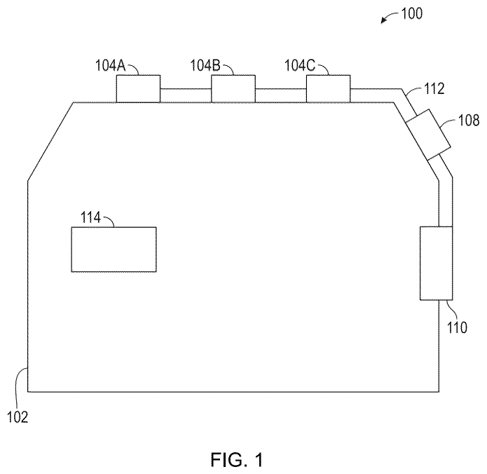

FIG. 1 illustrates an exterior view of a system 100 for extinguishing lithium-ion battery fires. The system 100 comprises a rigid container 102 appropriate for enclosing a lithium-ion battery fire in its entirety. In a preferred embodiment, the container 102 has dimensions rendering it appropriate for enclosing a vehicle powered by a lithium-ion battery. In another preferred embodiment, the container 102 can fold at its edges to facilitate transportation to the site of a lithium-ion battery fire. In yet another preferred embodiment, the container 102 is attached via a mechanical arm to an emergency vehicle such as a fire truck for facilitated deployment. Generally, the container 102 serves as not only a base upon which the remainder of the system 100 is constructed, but an essential safety and fire suppression component that prevents the escape of the extinguishing agents or the toxic products of the fire.

The container 102 serves as the primary containment structure for lithium-ion battery fires and must withstand the extreme conditions generated during such fire events. In a preferred embodiment, the container 102 is composed of a highly corrosion-resistant material such as Monel 400, which provides exceptional resistance to the hydrogen fluoride produced during lithium-ion battery fires. The material selection for container 102 addresses the unique challenges posed by lithium-ion battery fires, including exposure to corrosive gases and elevated temperatures that can exceed 1000° C. In another preferred embodiment, the container 102 is composed of materials that exhibit both heat-resistant and corrosion-resistant properties to effectively contain the toxic byproducts of lithium-ion battery fires. Suitable materials for this application include nickel alloys such as Hastelloy® or Inconel® alloys, which offer excellent resistance to both high temperatures and the corrosive environment created when lithium hexafluorophosphate decomposes during battery fires. Specialized stainless-steel alloys with high molybdenum content provide improved resistance to hydrofluoric acid compared to standard stainless steels, making them particularly effective for containing lithium-ion battery fires where HF production is a primary concern.

Alternative material compositions for container 102 include fluoropolymers like polytetrafluoroethylene (PTFE) or perfluoroalkoxy alkane (PFA), which exhibit exceptional chemical resistance and can withstand the high temperatures generated during lithium-ion battery fires. These fluoropolymer materials are particularly effective at resisting degradation from hydrogen fluoride exposure, a common hazard in lithium-ion battery fire scenarios. Ceramic materials such as silicon carbide or alumina provide excellent heat resistance and chemical inertness when containing lithium-ion battery fires, offering superior protection against thermal shock and chemical attack. In yet another preferred embodiment, composite materials or layered structures combining multiple materials may be used to provide optimal protection against both heat and corrosion during lithium-ion battery fire suppression operations. The specific choice of material for container 102 depends on factors such as the expected intensity and duration of the lithium-ion battery fire, as well as cost and manufacturing considerations. As illustrated in FIG. 1, the container 102 features a robust construction designed to maintain structural integrity throughout the lithium-ion battery fire suppression process.

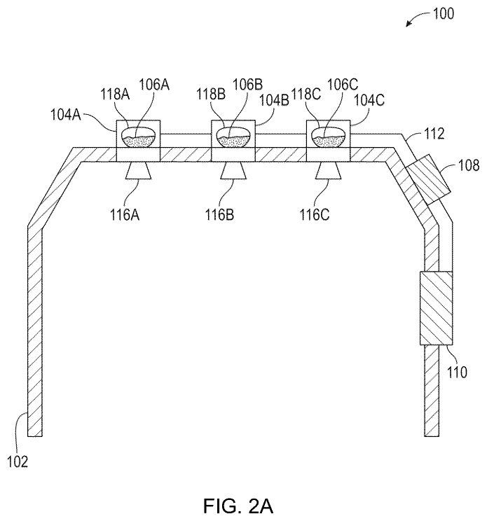

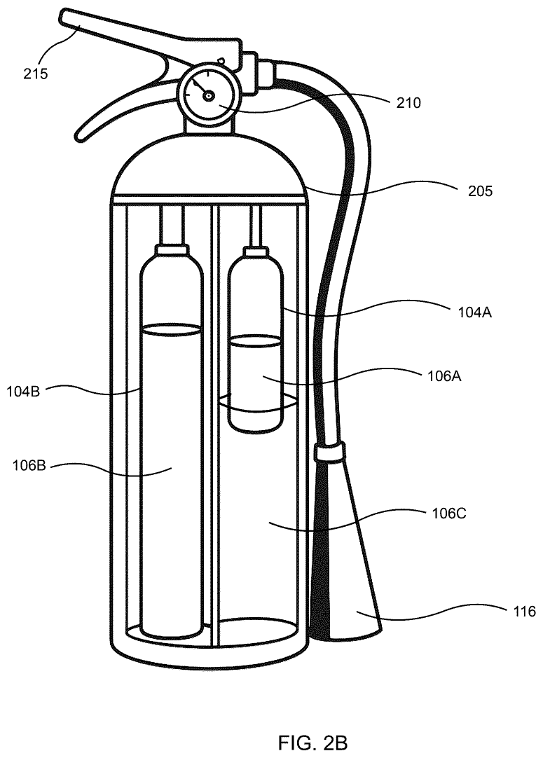

In a preferred embodiment, the system 100 incorporates multiple chemical storage cartridges or canisters 104 specifically designed for lithium-ion battery fire suppression applications. In a preferred embodiment, the canisters comprise three distinct units: first canister 104A, second canister 104B, and third canister 104C, each containing specialized agents for different phases of lithium-ion battery fire suppression. The multi-canister configuration enables a sequential deployment strategy that maximizes the effectiveness of each extinguishing agent during lithium-ion battery fire events. In another preferred embodiment, the system utilizes two canisters 104A and 104B for applications where simplified lithium-ion battery fire suppression is sufficient. The canisters 104 may be joined into a single housing to form a segmented canister 104, providing a compact solution for lithium-ion battery fire suppression in space-constrained environments. In some preferred embodiments, the canisters 104 are positioned on the top of the container 102 to ensure optimal distribution of extinguishing agents during lithium-ion battery fire suppression operations. Each canister 104 preferably contains a specific extinguishing agent 106 formulated to address different aspects of lithium-ion battery fire suppression and toxic gas mitigation. The extinguishing agents 106 are designed to operate effectively in the high-temperature environment characteristic of lithium-ion battery fires, where temperatures can rapidly escalate due to thermal runaway. In a preferred embodiment, each canister 104 contains a unique extinguishing agent 106 not shared by other canisters in the same system, allowing for targeted responses to different phases of lithium-ion battery fire development. The timing of extinguishing agent 106 dispersal from each canister 104 is controlled by signals from computing device 108, ensuring coordinated deployment during lithium-ion battery fire suppression operations. As illustrated in FIG. 2A, the construction and chemical properties of each canister 104 are determined by the chemical composition of its respective extinguishing agent 106 to ensure compatibility and safety during lithium-ion battery fire events. Alternative embodiments position the canisters 104 on lateral walls of the container 102, providing flexibility in system design while maintaining effective lithium-ion battery fire suppression capabilities.

In a preferred embodiment, the extinguishing agents 106 comprise at least one carbon source and at least one halogen source specifically selected for their effectiveness in lithium-ion battery fire suppression applications. The carbon source must be readily halogenated by both the halogen source and the ambient hydrogen fluoride produced during lithium-ion battery fires to generate effective fire suppressants. In a preferred embodiment, the carbon source comprises chloroform (CHCl₃), which reacts efficiently with hydrogen fluoride generated during lithium-ion battery fires to produce trifluoromethane intermediates. The chloroform-based carbon source provides rapid response capabilities when deployed against lithium-ion battery fires, particularly those involving lithium hexafluorophosphate electrolytes. In another preferred embodiment, the carbon source comprises iodoform (CHI₃), which offers alternative reaction pathways for lithium-ion battery fire suppression while producing different halogenated byproducts. Additional carbon source options include powdered graphite or carbon nanoparticles, which provide supplementary carbon for absorbing fluorine compounds produced during lithium-ion battery fires. The halogen source component of the extinguishing agents 106 is configured to operate within the high-temperature environment of lithium-ion battery fires to partially halogenate the carbon source in conjunction with ambient hydrogen fluoride. This halogenation process yields nonreactive gases that effectively suppress lithium-ion battery fires through oxygen displacement and flame inhibition mechanisms. In a preferred embodiment, the halogen source comprises iodine, which provides effective halogenation capabilities for lithium-ion battery fire suppression while producing stable organohalogen compounds. Aqueous bromine (Br_{2(aq)}) serves as another effective halogen source, offering both halogenation and cooling effects during lithium-ion battery fire suppression operations. In another preferred embodiment, elemental bromine provides rapid halogenation reactions suitable for emergency lithium-ion battery fire suppression scenarios. In some preferred embodiments, the halogen source constitutes the first extinguishing agent 106A contained within first canister 104A, ensuring immediate deployment during the initial phase of lithium-ion battery fire suppression.

The extinguishing agents 106 are preferably configured to work synergistically to cool the lithium-ion battery fire, convert toxic byproducts into fire suppressants, and neutralize corrosive compounds that pose risks to personnel and equipment. The initial cooling effect provided by the extinguishing agents 106 helps slow or halt the decomposition of lithium hexafluorophosphate (LiPF₆) into lithium fluoride (LiF) and phosphorus pentafluoride (PF₅), which represents a key driver of lithium-ion battery fires. This cooling mechanism also helps slow or halt the oxidative combustion of lithium metal within the battery cells, reducing the overall intensity of the lithium-ion battery fire. Subsequently, the extinguishing agents 106 react with hydrogen fluoride produced during the lithium-ion battery fire to generate fluorocarbons with proven fire suppression properties. In a preferred embodiment, the primary fluorocarbon produced is bromotrifluoromethane (CBrF₃), also known as Halon 1301, which provides highly effective suppression of lithium-ion battery fires through flame inhibition mechanisms. Alternatively, the system may be configured to produce organohalogen compounds during lithium-ion battery fire suppression, including dibromotetrafluoroethane (C₂Br₂F₃), also known as Halon 2402, which provides similar fire suppression capabilities for lithium-ion battery fires. In another preferred embodiment, the system generates iodotrifluoromethane (CIF₃) and related organohalogen compounds that effectively suppress lithium-ion battery fires while reducing toxic gas concentrations. The conversion process involves multiple sequential reactions where the carbon source first reacts with hydrogen fluoride to form trifluoromethane (CHF₃) or other fluorinated intermediates during lithium-ion battery fire suppression. The halogen source then reacts with these fluorinated compounds to produce fire suppressing gases that effectively smother lithium-ion battery fires and prevent further combustion. When chloroform serves as the carbon source, hydrogen chloride is produced as a byproduct, which forms hydrochloric acid when mixed with water present during lithium-ion battery fire suppression operations. This conversion process not only helps extinguish lithium-ion battery fires but also significantly reduces the amount of toxic hydrogen fluoride present at the fire site.

Following successful suppression of the lithium-ion battery fire, an optional final step involves applying a specialized clean-up agent 106C designed to neutralize residual toxic compounds. The clean-up agent serves to neutralize or absorb the toxic products generated by the combination of the lithium-ion battery fire, the extinguishing agents 106A and 106B, and the chemical quenching reactions. This clean-up agent 106C is formulated to neutralize acids, decompose toxic byproducts such as carbonyl halide gases, scavenge elemental fluorine or fluoride anions, and bind elemental or aqueous halogens remaining after lithium-ion battery fire suppression. In a preferred embodiment, the clean-up agent 106C comprises activated carbon nanoparticles, powdered graphite, calcium bicarbonate (Ca(HCO₃)₂), and sodium bicarbonate (NaHCO₃), which work together to neutralize the acidic environment created during lithium-ion battery fire suppression. The clean-up agent 106C may be formulated as an aqueous suspension or solution to facilitate distribution and enhance its effectiveness in neutralizing residual hazards from lithium-ion battery fires. As illustrated in FIG. 2A, the clean-up agent 106C is contained within third canister 104C and deployed after the primary lithium-ion battery fire suppression sequence is complete.

The timing of clean-up agent 106C deployment is carefully controlled to ensure optimal effectiveness following lithium-ion battery fire suppression operations. In some preferred embodiments, the clean-up agent 106C is discharged after the temperature has been sufficiently lowered such that lithium hexafluorophosphate (LiPF₆) is no longer undergoing decomposition, preventing further generation of toxic compounds during lithium-ion battery fire cleanup. The clean-up agent 106C may comprise multiple chemical compounds that require separation to prevent unwanted reactions, particularly when dealing with the complex chemical environment following lithium-ion battery fire suppression. For example, a clean-up agent 106C containing solutions of calcium bicarbonate (Ca(HCO₃)₂) and sodium sulfite (Na₂SO₃) as a bromine scavenger may utilize separate repositories within canister 104C to prevent premature reactions. These distinct repositories enable sequential deployment of different clean-up components to maximize their effectiveness in neutralizing residual hazards from lithium-ion battery fires. The clean-up agent 106C formulation can be customized based on the specific types of lithium-ion battery fires encountered and the particular toxic compounds that require neutralization.

In a preferred embodiment, the canisters 104 and their contents are integrated through circuit 112 with sensor 110 and computing device 108 to provide automated response capabilities for lithium-ion battery fire suppression. This integrated control system enables rapid detection and response to lithium-ion battery fires, minimizing the time between fire initiation and suppression system activation. In a preferred embodiment, the circuit 112 comprises wiring exterior to the container 102, providing accessible connections for maintenance and system monitoring during lithium-ion battery fire suppression operations. The computing device 108 controls the discharge sequence of each canister 104 based on multiple input signals, ensuring coordinated deployment of extinguishing agents during lithium-ion battery fire events. In another preferred embodiment, the circuit 112 comprises wiring built into the walls of container 102, providing protected connections that resist damage during lithium-ion battery fire suppression operations. The computing device 108 automatically triggers the discharge of one or more canisters 104 when sensor 110 indicates the presence of a lithium-ion battery fire within container 102, enabling immediate response without human intervention.

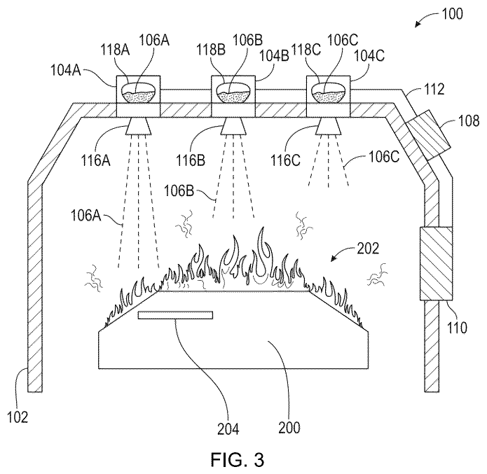

Alternative control modes for the computing device 108 include manual activation by users and remote signal reception for lithium-ion battery fire suppression operations. In some preferred embodiments, the computing device 108 triggers the discharge of one or more canisters 104 when a user manually inputs a command, providing operator control during lithium-ion battery fire emergencies. The system can receive remote signals from other computing devices or users, enabling coordinated response to lithium-ion battery fires from external command centers or emergency response teams. The computing device 108 may implement a predetermined sequence for discharging each canister 104 based on preprogrammed time intervals upon receiving a start signal for lithium-ion battery fire suppression. This sequential deployment strategy ensures optimal timing for each extinguishing agent during lithium-ion battery fire suppression operations, maximizing the effectiveness of the chemical reactions. As illustrated in FIG. 3, the integrated control system coordinates the deployment of extinguishing agents 106A, 106B, and clean-up agent 106C during active lithium-ion battery fire suppression scenarios.

The sensor 110 provides continuous monitoring of environmental conditions within container 102 to detect the onset and progression of lithium-ion battery fires. This monitoring capability enables early detection of lithium-ion battery fires, allowing for rapid deployment of extinguishing agents before the fire can escalate to dangerous levels. In a preferred embodiment, the sensor 110 comprises a fluorine or hydrogen fluoride sensor specifically designed to detect the toxic gases produced during lithium-ion battery fires. The fluorine detection capability is particularly important for lithium-ion battery fire applications, as hydrogen fluoride production represents one of the most dangerous aspects of these fire events. Temperature sensors provide additional monitoring capabilities for detecting the thermal signatures associated with lithium-ion battery fires, including the rapid temperature increases characteristic of thermal runaway events. Heat flux sensors offer advanced detection capabilities by measuring the rate of heat transfer during lithium-ion battery fires, providing early warning of developing fire conditions. Additional sensor configurations may be used to enhance the system's ability to detect and respond to various types of lithium-ion battery fire scenarios. Smoke sensors provide supplementary detection capabilities for lithium-ion battery fires that may not immediately produce significant hydrogen fluoride concentrations but generate visible combustion products. In another preferred embodiment, the sensor 110 transfixes the wall of container 102, with its primary sensory components located on the interior to directly monitor conditions during lithium-ion battery fires. Multiple sensors may be distributed throughout container 102 to provide comprehensive coverage and redundant detection capabilities for lithium-ion battery fire monitoring. In some preferred embodiments, the sensor 110 and computing device 108 are integrated into a single device with both sensory and computing capabilities, simplifying the system architecture for lithium-ion battery fire suppression applications. The sensor 110 may transmit signals remotely to computing devices not localized about container 102, such as emergency response equipment, enabling coordinated response to lithium-ion battery fires from multiple locations.

In some preferred embodiments, visual monitoring capabilities are provided through viewing windows 114 that enable observation of lithium-ion battery fires without compromising the containment integrity of container 102. These viewing windows 114 permit real-time assessment of lithium-ion battery fire suppression progress while preventing the escape of toxic gases through openings in the containment system. In a preferred embodiment, the viewing window 114 is integrated into the lateral side of container 102, providing clear visualization of the interior during lithium-ion battery fire suppression operations. The viewing window 114 enables operators to monitor the effectiveness of extinguishing agents during lithium-ion battery fire suppression and determine when additional interventions may be necessary. Alternative positioning includes mounting the viewing window 114 in the top of container 102, offering different viewing angles for lithium-ion battery fire assessment. The viewing window 114 maintains a sealed configuration throughout lithium-ion battery fire suppression operations, preventing the leakage of toxic gases while enabling visual monitoring. The construction materials for viewing window 114 are preferably selected for their transparency, corrosion resistance, and high melting point to withstand the extreme conditions of lithium-ion battery fires. In a preferred embodiment, the viewing window 114 comprises synthetic corundum, which provides excellent optical clarity and exceptional resistance to the corrosive environment created during lithium-ion battery fires. Borosilicate glass represents another suitable material for viewing window 114, offering good thermal shock resistance and chemical inertness during lithium-ion battery fire suppression operations. The viewing window 114 enables easy verification of whether combustion reactions are still active during lithium-ion battery fire suppression, which affects the timing of clean-up procedures and safety measures. Visual monitoring through viewing window 114 helps determine the appropriate timing for deploying clean-up agents and implementing precautionary measures to protect personnel and the environment during lithium-ion battery fire incidents. As illustrated in FIG. 1, the viewing window 114 provides a transparent interface for monitoring lithium-ion battery fire suppression operations while maintaining the containment integrity of the system.

As illustrated in FIG. 2A, the cross-sectional view of the system 100 reveals the interior configuration of the container 102 and canisters 104, demonstrating the strategic positioning of components for optimal lithium-ion battery fire suppression. The canister nozzles 116 are positioned within the interior of the container 102, with each nozzle attached to and operatively associated with its respective canister 104 to ensure coordinated deployment of extinguishing agents during lithium-ion battery fire events. The primary function of the canister nozzles 116 is to direct the extinguishing agents 106 in a manner that maximizes their effectiveness in suppressing lithium-ion battery fires, particularly those involving thermal runaway conditions that generate intense heat and toxic gases. In a preferred embodiment, the nozzles 116 are engineered to distribute the extinguishing agents 106 in a broad, spread-out spray pattern that provides comprehensive coverage of the lithium-ion battery fire area, ensuring that all affected battery cells receive adequate suppressant material. In another preferred embodiment, the nozzles 116 are configured to project the extinguishing agents 106 in a concentrated, directed stream toward the specific location of the lithium-ion battery fire, allowing for precise targeting of individual battery modules or cells experiencing thermal runaway. In some preferred embodiments, the nozzles 116 incorporate adjustable mechanisms that enable real-time modification of the spray pattern and flow rate based on the specific characteristics and intensity of the lithium-ion battery fire being suppressed.

The cross-sectional view reveals that within each canister 104 is a specialized chemical repository 118 designed to safely store and maintain the integrity of the respective extinguishing agent 106 under conditions suitable for rapid deployment during lithium-ion battery fire emergencies. In a preferred embodiment, each extinguishing agent 106A, 106B, 106C is maintained under controlled pressure within its repository to facilitate immediate and efficient dispersal upon activation, ensuring rapid response times when lithium-ion battery fires are detected. The pressurization system enables the extinguishing agents to be expelled through the nozzles 116 with sufficient force and velocity to penetrate the intense heat and gas plumes generated by lithium-ion battery fires, particularly those involving lithium hexafluorophosphate decomposition. In another preferred embodiment, the repositories 118A, 118B, 118C are pressurized using chemically inert gases such as nitrogen or argon, which serve the dual purpose of preventing degradation of the stored extinguishing agents over extended periods while simultaneously providing additional fire suppression capability through oxygen displacement when released into the container 102 during lithium-ion battery fire suppression operations. The inert gas pressurization system helps maintain the chemical stability of reactive components such as bromine sources and carbon sources that are essential for generating organohalogens during lithium-ion battery fire suppression. In some preferred embodiments, the repositories 118 are constructed with reinforced walls and specialized interior coatings to withstand high internal pressures while resisting chemical corrosion from the stored extinguishing agents, with materials such as fluorocarbon polymer linings being particularly effective for repositories containing halogen sources used in lithium-ion battery fire suppression applications.

As illustrated in FIG. 2B, some preferred embodiments comprise a portable handheld fire extinguishing system specifically engineered for suppressing lithium-ion battery fires in smaller applications such as consumer electronics, e-bikes, and portable power tools. The handheld configuration includes a main canister 205 that serves as the primary housing and structural foundation for the entire fire suppression assembly, providing both storage capacity and operational control for emergency response scenarios. In a preferred embodiment, the main canister 205 incorporates a pressure gauge 210 that enables users to monitor the internal pressure levels and verify system readiness before deployment against lithium-ion battery fires. The system further includes a trigger 215 mechanism that allows for manual activation and controlled discharge of extinguishing agents when lithium-ion battery thermal runaway events are detected or anticipated. A specialized nozzle 116 extends from the main canister 205 and is configured to direct the flow of extinguishing agents with precision toward the specific location of lithium-ion battery fires, ensuring optimal coverage and penetration into battery compartments. The handheld design facilitates rapid deployment by first responders, homeowners, or facility personnel who encounter lithium-ion battery fire emergencies in residential, commercial, or industrial settings.

The internal configuration of the handheld system incorporates multiple specialized compartments designed to store different extinguishing agents required for effective lithium-ion battery fire suppression. In another preferred embodiment, the main canister 205 houses a first canister 104A containing a first extinguishing agent 106A, which may comprise a halogen source such as aqueous bromine specifically formulated to react with hydrogen fluoride produced during lithium-ion battery fires. Adjacent to the first canister 104A, a second canister 104B contains a second extinguishing agent 106B, which typically comprises a carbon source such as chloroform that facilitates the generation of fire-suppressing organohalogens when combined with the halogen source. The system also incorporates a clean-up agent 106C stored within the main canister 205, designed to neutralize residual toxic compounds and acids produced during the lithium-ion battery fire suppression process. In some preferred embodiments, these extinguishing agents and clean-up agent are deposited within specialized repositories 118 integrated into the main canister 205 and subsidiary canisters 104A, 104B to maintain chemical stability and prevent premature reactions. The repository design ensures that each agent remains isolated until deployment, maximizing the effectiveness of the chemical reactions that convert toxic hydrogen fluoride into fire-suppressing compounds during lithium-ion battery fire events. This multi-agent approach enables the handheld system to address both the immediate fire suppression needs and the subsequent cleanup requirements associated with lithium-ion battery fires in portable applications.

In some preferred embodiments, the utilization of bromine mixed with water as an extinguishing agent in lithium-ion battery fire applications provides benefits that enhance the overall effectiveness of the fire suppression system. When aqueous bromine is deployed onto a lithium-ion battery fire, the water component immediately begins to absorb thermal energy from the combustion zone, reducing the temperature of the affected battery cells and slowing the rate of thermal runaway propagation throughout the battery pack. This cooling effect may help interrupt the self-sustaining exothermic reactions that characterize lithium-ion battery fires, particularly the decomposition of lithium hexafluorophosphate into lithium fluoride and phosphorus pentafluoride. Simultaneously, the heat from the fire causes the aqueous bromine solution to vaporize, releasing bromine gas into the enclosed environment where it becomes available for subsequent chemical reactions with hydrogen fluoride and fluorinated carbon compounds. The vaporized bromine serves as a reactive halogen source that participates in the formation of fire-suppressing organohalogens such as bromotrifluoromethane, which effectively inhibit combustion through flame suppression mechanisms. In some preferred embodiments, the concentration of bromine in the aqueous solution may be optimized to balance the cooling capacity provided by the water with the halogenation capacity provided by the bromine, ensuring that both fire suppression mechanisms operate at maximum efficiency during lithium-ion battery fire events. The aqueous bromine formulation also provides advantages in terms of storage stability and handling safety compared to pure elemental bromine, as the water serves to moderate the reactivity of the bromine while maintaining its effectiveness as a fire extinguishing agent when deployed against lithium-ion battery fires. The dual-action mechanism of aqueous bromine, combining immediate thermal management with subsequent chemical fire suppression, makes it particularly well-suited for addressing the complex challenges posed by lithium-ion battery thermal runaway scenarios where both rapid cooling and sustained flame inhibition are required for successful fire suppression. The use of bromine mixed with water may be particularly useful for the portable handheld fire extinguishing system.

FIG. 3 illustrates a cross-sectional view of the system 100 in active operation, demonstrating the comprehensive suppression of lithium-ion battery fires through coordinated deployment of specialized extinguishing agents. The container 102 provides complete enclosure of the lithium battery-powered device 200, creating a controlled environment that prevents the escape of toxic gases and flames during fire suppression operations. In a preferred embodiment, the lithium battery-powered device 200 comprises an electric vehicle equipped with high-capacity lithium-ion battery packs that require specialized fire suppression techniques due to their propensity for thermal runaway events. In another preferred embodiment, the lithium battery-powered device 200 represents an energy storage system designed for collecting and storing renewable energy from solar panels or wind turbines, where lithium-ion battery fires pose significant risks to infrastructure and personnel. The lithium battery-powered device 200 incorporates one or more lithium-ion batteries 204 that contain lithium hexafluorophosphate electrolytes, which decompose during fire events to produce highly toxic and corrosive compounds. During malfunction scenarios such as physical damage, overcharging, or manufacturing defects, the chemical components within the lithium-ion battery 204 undergo exothermic reactions that rapidly spread throughout the device, initiating the combustion reaction 202 that characterizes lithium-ion battery fires.

The detection and response mechanism of the system 100 enables rapid identification and suppression of lithium-ion battery fires through continuous monitoring of environmental conditions within the container 102. In a preferred embodiment, the elevated temperatures generated by the combustion reaction 202, combined with the release of fluorine-containing compounds such as hydrogen fluoride produced during lithium hexafluorophosphate decomposition, are immediately detected by the sensor 110 positioned within the containment system. The sensor 110 transmits comprehensive data signals containing temperature measurements, chemical detection information, and fire intensity indicators to the computing device 108 for processing and analysis. In some preferred embodiments, this data transmission occurs via the circuit 112 that provides hardwired communication pathways between system components, ensuring reliable signal transmission even under extreme fire conditions. In another preferred embodiment, the sensor 110 utilizes wireless transmission capabilities to send detection data remotely to the computing device 108, enabling system operation in scenarios where physical wiring may be compromised by fire damage. The computing device 108 processes the incoming sensor data using predetermined algorithms and threshold values to determine whether conditions warrant the immediate discharge of extinguishing agents 106 from the respective canisters 104.

As illustrated in FIG. 3, the systematic coordination between detection, processing, and response components enables the system 100 to provide automated fire suppression capabilities specifically tailored for lithium-ion battery fire scenarios. In yet another preferred embodiment, the computing device 108 functions as an alert system that notifies emergency personnel or facility operators of detected fire conditions, allowing human operators to make informed decisions regarding the activation of extinguishing agent discharge based on real-time sensor data and visual observations through the viewing window 114. Once the determination for fire suppression activation is made, the computing device 108 generates and transmits precise control instructions to the canisters 104A, 104B, and 104C, initiating the coordinated release sequence of extinguishing agents designed to suppress lithium-ion battery fires through chemical conversion and cooling mechanisms. The strategic timing of extinguishing agent deployment represents a fundamental aspect of effective lithium-ion battery fire suppression, where the first canister 104A containing aqueous bromine (Br_{2(aq)}) provides immediate cooling effects while simultaneously vaporizing bromine for subsequent chemical reactions with hydrogen fluoride produced by the lithium-ion battery fire. The water component of the aqueous bromine solution serves the dual purpose of reducing the temperature of the combustion reaction 202 while the heat energy from the fire facilitates the vaporization of Br₂, creating optimal conditions for organohalogen generation when combined with carbon sources. Following this initial cooling and bromine vaporization phase, the second canister 104B discharges its carbon source contents into the container 102, where the carbon compounds react with the vaporized bromine and ambient hydrogen fluoride to produce fire-suppressing organohalogens such as bromotrifluoromethane. This sequential deployment strategy maximizes the effectiveness of organohalogen generation while minimizing the formation of undesired reaction byproducts that could compromise fire suppression efficiency or create additional safety hazards during lithium-ion battery fire suppression operations.

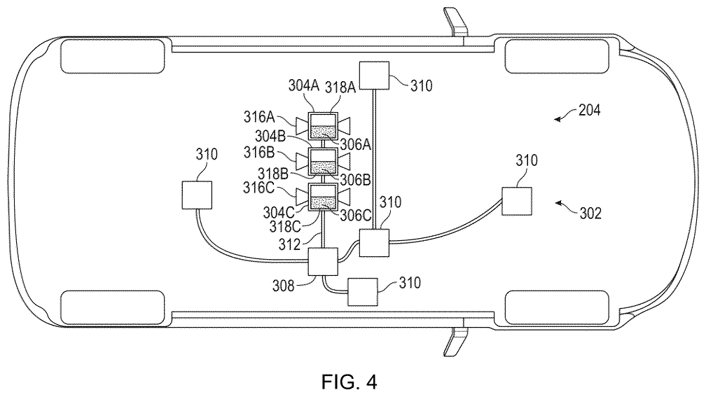

As illustrated in FIG. 4, the vehicle-based fire extinguishing system 300 represents a specialized embodiment designed specifically for suppressing lithium-ion battery fires in automotive applications where thermal runaway events pose significant safety risks. The system 300 integrates directly into the vehicle frame 302, which provides structural support and protection for the lithium-ion battery 204 while accommodating the fire suppression components. In a preferred embodiment, the primary fire suppression components are strategically positioned toward the center of the lithium-ion battery 204 to minimize vulnerability to impact damage during vehicular collisions, which represent a common cause of lithium-ion battery fires in electric vehicles. The centralized positioning ensures that the extinguishing agents can be deployed effectively across the battery pack while maintaining system integrity during normal vehicle operation. Material selection for the vehicle frame 302 and lithium-ion battery 204 exterior casing emphasizes impact resistance and durability to prevent fire-inducing damage from collisions or other mechanical stresses. The integrated design approach enables the fire suppression system to operate seamlessly within the vehicle's existing architecture while providing comprehensive protection against lithium-ion battery fire hazards.

The vehicle-based system incorporates three specialized canisters 304A, 304B, and 308C that contain respective extinguishing agents 306A, 306B, and 306C stored within repositories 318A, 318B, and third repository for effective suppression of lithium-ion battery fires. In another preferred embodiment, these canisters are positioned centrally on the top surface of the lithium-ion battery 204 to ensure optimal distribution of fire suppressing agents during thermal runaway events. The lithium-ion battery 204 may constitute the primary structural base of the vehicle, requiring the fire suppression system to provide comprehensive coverage across the entire battery pack area. When lithium-ion battery fires occur, the sensors 310 detect multiple fire indicators including fluorine compounds, hydrofluoric acid, and elevated temperatures that characterize lithium hexafluorophosphate decomposition. The sensors 310 transmit electrical signals containing detection data to the computing device 308 via the electrical circuit 312, enabling rapid automated response to lithium-ion battery fire conditions. In some preferred embodiments, the canisters 304A, 304B, and 308C are pressurized with inert gases such as nitrogen to facilitate immediate discharge of extinguishing agents 306A, 306B, and 306C through their respective nozzles 316A, 316B, and 316C when lithium-ion battery fires are detected. The computing device 308 processes sensor data and issues discharge instructions to the appropriate canisters based on the specific location and intensity of the detected lithium-ion battery fire, ensuring targeted suppression while conserving extinguishing agent resources.

The vehicle-based fire extinguishing system 300, as illustrated in FIG. 4, may be incorporated into electric vehicles during the manufacturing process to provide integrated protection against lithium-ion battery fires throughout the vehicle's operational lifetime. In a preferred embodiment, the canisters 304A, 304B, and 308C are mounted directly onto the structural housing of the lithium-ion battery 204, with the vehicle frame 302 modified to accommodate the fire suppression components without compromising passenger space or cargo capacity. The sensors 310 may be distributed at multiple locations throughout the battery pack to ensure comprehensive monitoring of all battery modules, with particular attention to areas most susceptible to thermal runaway initiation such as battery cell interconnections and high-current terminals. As illustrated in FIG. 4, the computing device 308 may be integrated with the vehicle's existing electronic control systems, allowing the fire suppression system to communicate with other vehicle safety systems and provide coordinated emergency responses. The circuit 312 may be routed through protective conduits within the vehicle frame 302 to shield electrical connections from mechanical damage, moisture exposure, and electromagnetic interference that could compromise system reliability. In another preferred embodiment, the nozzles 316A, 316B, and 316C are positioned to direct extinguishing agents toward specific zones within the battery pack, with adjustable spray patterns that can be optimized based on the battery pack configuration and cell arrangement used in different electric vehicle models.

The integration of the fire suppression system into electric vehicles may involve coordination with existing vehicle safety systems to provide comprehensive protection during various operational scenarios. In some preferred embodiments, the sensors 310 may be connected to the vehicle's onboard diagnostic system, enabling real-time monitoring of battery health parameters and early detection of conditions that could lead to thermal runaway events in lithium-ion battery fires. The computing device 308 may receive input signals from the vehicle's collision detection system, allowing for preemptive activation of fire suppression measures when impact sensors detect forces that could damage the lithium-ion battery 204 and initiate combustion reactions. The repositories 318A and 318B may be designed with mounting brackets that attach to reinforced sections of the vehicle frame 302, ensuring that the extinguishing agent storage remains secure during normal driving conditions and collision events. As illustrated in FIG. 4, the positioning of the fire suppression components may be optimized to maintain the vehicle's center of gravity and weight distribution, preventing adverse effects on handling characteristics and ride quality. In a preferred embodiment, the system may include redundant sensors 310 and multiple circuit 312 pathways to ensure continued operation even if some components are damaged during an accident that triggers lithium-ion battery fires. The integration approach may also consider serviceability requirements, with canisters 304A, 304B, and 308C designed for periodic inspection and replacement without requiring extensive disassembly of the vehicle structure.

Electric vehicles incorporating the fire suppression system may benefit from enhanced safety features that address the unique challenges of lithium-ion battery fires in automotive applications. In another preferred embodiment, the computing device 308 may be programmed with vehicle-specific parameters that account for the particular battery chemistry, cell configuration, and thermal management characteristics of different electric vehicle models. The system may include communication interfaces that transmit fire detection and suppression status information to external emergency response systems, enabling first responders to receive real-time data about lithium-ion battery fire conditions before arriving at the scene. The nozzles 316A, 316B, and 316C may incorporate check valves and pressure regulators that ensure consistent agent delivery even when the vehicle is positioned at various angles following a collision or rollover event. As illustrated in FIG. 4, the fire suppression system may be designed to operate independently of the vehicle's main electrical system, with dedicated power sources such as backup batteries or capacitors that maintain functionality even when primary vehicle power is interrupted. In some preferred embodiments, the extinguishing agents 306A, 306B, and 306C may be formulated specifically for the operating temperature range and environmental conditions expected in automotive applications, ensuring effectiveness across diverse climate zones and seasonal variations. The vehicle integration may also include provisions for manual activation of the fire suppression system by vehicle occupants or emergency personnel, providing an additional layer of safety control beyond the automated detection and response mechanisms.

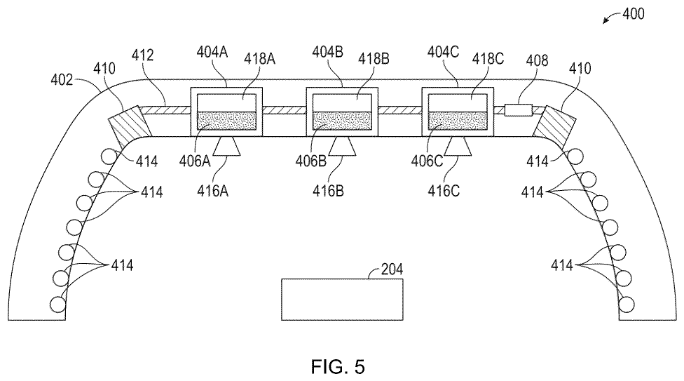

As illustrated in FIG. 5, the system 400 represents a specialized fireproof blanket-based extinguishing system specifically engineered for suppressing lithium-ion battery fires in portable and small-scale applications. The system 400 provides an effective solution for extinguishing fires caused by lithium-ion batteries in consumer electronics such as e-bicycles, electric scooters, hoverboards, and similar personal mobility devices that have become increasingly common in residential and commercial environments. In a preferred embodiment, the system 400 is deployed to suppress lithium-ion battery fires in household appliances including cordless vacuum cleaners, power tools, and portable electronic devices where traditional fire suppression methods may prove inadequate. The fireproof blanket 402 serves as the primary containment structure, preventing the spread of toxic gases and flames while creating a controlled environment for chemical fire suppression reactions. In another preferred embodiment, the blanket 402 incorporates multiple layers of fire-resistant materials specifically selected for their ability to withstand the extreme temperatures generated during lithium-ion battery thermal runaway events. The system 400 addresses the unique challenges posed by lithium-ion battery fires in confined spaces where conventional fire suppression systems cannot be effectively deployed.

The construction materials for the fireproof blanket 402 are carefully selected to provide optimal protection against the corrosive and high-temperature conditions characteristic of lithium-ion battery fires. In a preferred embodiment, the blanket 402 comprises mineral wool or specialized silica-based fabrics that offer exceptional resistance to the hydrogen fluoride and other toxic compounds produced during lithium hexafluorophosphate decomposition in lithium-ion battery fires. The mineral wool construction provides excellent thermal insulation properties while maintaining structural integrity even when exposed to temperatures exceeding 1000° C. commonly encountered in lithium-ion battery thermal runaway scenarios. In another preferred embodiment, the blanket 402 utilizes layered aramid fiber construction incorporating materials such as Kevlar® or Nomex®, which provide superior tensile strength and chemical resistance when suppressing lithium-ion battery fires. Alternative material configurations include fiberglass fabrics treated with specialized fire-resistant coatings that enhance the blanket's ability to contain toxic gases produced during lithium-ion battery combustion. In some preferred embodiments, the blanket 402 incorporates carbon fiber materials that serve the dual purpose of providing fire resistance while acting as a supplemental carbon source for absorbing fluorine compounds and facilitating the production of fire-suppressing organohalogens during lithium-ion battery fire suppression operations.

The strategic distribution of weights 414 throughout the fireproof blanket 402 provides essential containment capabilities for suppressing lithium-ion battery fires by ensuring complete contact between the blanket and the surface surrounding the fire. The primary function of the weights 414 involves creating an effective seal that prevents the escape of toxic gases and flames generated during lithium-ion battery thermal runaway events, while simultaneously smothering the fire through oxygen displacement. In a preferred embodiment, the weights 414 are positioned around the perimeter edges of the blanket 402 to facilitate comprehensive containment of lithium-ion battery fires and their hazardous byproducts. The weight distribution system ensures that the blanket 402 maintains intimate contact with floors, ground surfaces, or other substrates where lithium-ion battery fires may occur, preventing the infiltration of ambient oxygen that could sustain combustion reactions. In another preferred embodiment, the weights 414 are integrated directly into the fabric structure of the blanket 402 through specialized sewing techniques that secure the weights while maintaining the blanket's flexibility and deployment characteristics. In some preferred embodiments, the weights 414 are contained within heat-resistant pouches that are sewn into the blanket lining, providing protection against the extreme temperatures encountered during lithium-ion battery fire suppression while ensuring the weights remain securely positioned throughout the suppression process.

The selection of materials for constructing the weights 414 emphasizes properties that enhance the effectiveness of lithium-ion battery fire suppression while ensuring safety and durability under extreme operating conditions. Material selection criteria include high density for maximum containment effectiveness, chemical inertness to prevent unwanted reactions with lithium-ion battery fire byproducts, non-toxicity to ensure personnel safety, and compatibility with the blanket construction methods. In a preferred embodiment, the weights 414 comprise steel shot or pellets that provide exceptional density while maintaining chemical stability when exposed to the corrosive environment created during lithium-ion battery fires. Steel-based weights offer advantages in applications where toxicity concerns preclude the use of lead materials, particularly in residential environments or facilities frequented by children and pregnant women where lithium-ion battery fires may occur. In another preferred embodiment, lead pellets may be utilized for the weights 414 in applications where maximum density is required for effective containment of lithium-ion battery fires, though such applications must consider appropriate safety protocols for lead exposure. Alternative weight configurations include small metal disks or washers distributed throughout the blanket structure, providing uniform weight distribution that enhances the blanket's ability to conform to irregular surfaces during lithium-ion battery fire suppression operations. In some preferred embodiments, silica-based materials such as sand or fine gravel are enclosed within durable pouches positioned at strategic locations throughout the blanket, offering cost-effective weight solutions while maintaining chemical compatibility with lithium-ion battery fire suppression agents.

Additional weight material options include glass beads that provide uniform density distribution while maintaining chemical inertness during lithium-ion battery fire suppression operations. Ceramic materials and dense polymers such as polypropylene or polyethylene can be formed into beads or pellets that offer excellent weight characteristics combined with superior chemical resistance to the corrosive compounds produced during lithium-ion battery fires. These polymer-based weight materials provide advantages in terms of manufacturing flexibility and cost-effectiveness while maintaining the performance characteristics required for effective lithium-ion battery fire containment. In a preferred embodiment, the weight materials are selected based on the specific application requirements, with considerations for the expected intensity and duration of lithium-ion battery fires in the target environment. Cost-effective implementations may utilize natural materials such as small pebbles or stones for the weights 414, providing adequate density for containment while minimizing system costs for applications where lithium-ion battery fire suppression requirements are less demanding. The weight material selection process considers factors such as thermal stability, chemical compatibility with extinguishing agents, and long-term durability under storage conditions to ensure reliable performance when lithium-ion battery fire suppression is required.

The integrated canister system within the fireproof blanket 402 comprises specialized canisters 404A, 404B, and 404C that house the repositories 418A, 418B, and 418C containing the respective extinguishing agents 406A, 406B, and 406C specifically formulated for lithium-ion battery fire suppression. As illustrated in FIG. 5, these canisters are strategically embedded within the blanket structure to provide optimal distribution of fire suppression agents while maintaining the blanket's flexibility and deployment characteristics. In a preferred embodiment, the canisters 404A, 404B, and 404C comprise pressurized cartridges utilizing inert gases such as argon to facilitate rapid deployment of extinguishing agents when lithium-ion battery fires are detected. The pressurization system ensures immediate response capabilities while preventing degradation of the stored chemical agents during extended storage periods between lithium-ion battery fire incidents. The extinguishing agents 406A and 406B substantially correspond to the previously described halogen sources and carbon sources that react with hydrogen fluoride produced during lithium-ion battery fires to generate fire-suppressing organohalogens. In another preferred embodiment, the clean-up agent 406C provides neutralization capabilities for residual toxic compounds remaining after successful suppression of lithium-ion battery fires, ensuring safe cleanup and disposal of contaminated materials.

The nozzle system comprising nozzles 416A, 416B, and 416C provides precise directional control for dispersing the extinguishing agents 406A, 406B, and 406C onto lithium-ion battery fires with optimal coverage and penetration characteristics. Each nozzle is specifically designed to accommodate the unique properties of its respective extinguishing agent while ensuring effective distribution patterns that maximize fire suppression efficiency during lithium-ion battery thermal runaway events. In a preferred embodiment, the nozzles 416A, 416B, and 416C are positioned to direct the extinguishing agents toward the most likely locations of lithium-ion battery fires based on typical failure modes and thermal runaway propagation patterns. The nozzle design incorporates features that prevent clogging and ensure consistent flow rates even under the extreme temperature and chemical conditions encountered during lithium-ion battery fire suppression operations. The integrated circuit 412 provides electrical connectivity between the canisters 404A, 404B, and 404C, the computing device 408, and the sensors 410, enabling coordinated deployment of extinguishing agents based on real-time detection of lithium-ion battery fire conditions. In some preferred embodiments, the circuit 412 utilizes flexible wiring configurations that maintain electrical continuity even when the blanket 402 is folded, deployed, or subjected to the mechanical stresses associated with lithium-ion battery fire suppression operations.

The detection and response mechanism of the system 400 enables rapid identification and automated suppression of lithium-ion battery fires through continuous monitoring of environmental conditions beneath the fireproof blanket 402. The sensors 410 are specifically configured to detect the characteristic indicators of lithium-ion battery fires, including elevated temperatures associated with thermal runaway and the presence of fluorine-containing compounds such as hydrogen fluoride produced during lithium hexafluorophosphate decomposition. In a preferred embodiment, the sensors 410 transmit comprehensive data signals containing temperature measurements and chemical detection information to the computing device 408 via the circuit 412, enabling real-time assessment of lithium-ion battery fire conditions. The computing device 408 processes the incoming sensor data using predetermined algorithms and threshold values to determine whether conditions warrant immediate discharge of extinguishing agents 406A, 406B, and 406C for lithium-ion battery fire suppression. In another preferred embodiment, the computing device 408 functions as an alert system that notifies users of detected fire conditions, allowing human operators to make informed decisions regarding activation of the extinguishing agent discharge sequence based on real-time sensor data and visual observations. The system provides flexibility in deployment strategies, with options for fully automated response to lithium-ion battery fires or user-controlled activation based on specific operational requirements and safety protocols.

The sequential deployment strategy for extinguishing agents in the system 400 ensures optimal timing and effectiveness when suppressing lithium-ion battery fires through coordinated chemical reactions and cooling mechanisms. Once the determination for fire suppression activation is made, the computing device 408 generates precise control instructions that are transmitted to the canisters 404A, 404B, and 404C via the circuit 412, initiating the coordinated release sequence designed specifically for lithium-ion battery fire suppression. In a preferred embodiment, the first canister 404A receives the initial discharge instruction, releasing its halogen source contents to begin the cooling process and provide reactive compounds for subsequent organohalogen generation during lithium-ion battery fire suppression. The timing of subsequent agent releases is carefully controlled to maximize the effectiveness of chemical reactions between the extinguishing agents and the toxic byproducts of lithium-ion battery fires. In another preferred embodiment, the second canister 404B is programmed to discharge its carbon source contents after a predetermined time interval that allows for optimal vaporization of the halogen source and establishment of appropriate reaction conditions for lithium-ion battery fire suppression. The clean-up agent 406C contained in the third canister 404C is deployed only after the sensors 410 detect reduced temperatures and diminished fire activity beneath the blanket 402, ensuring that the neutralization process occurs under safe conditions that prevent interference with the primary fire suppression reactions targeting lithium-ion battery fires.

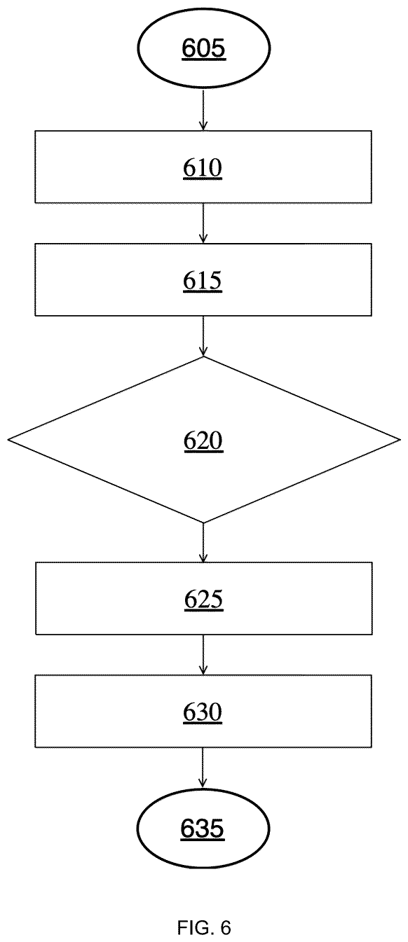

FIG. 6 is a flow diagram 600 illustrating a method for using a system comprising a container to extinguish a Lithium-ion battery fire. Step 605 begins the method. During step 610, the container 102 may be positioned to enclose a lithium-ion battery or a device containing such a battery. The container 102 may be designed to fully contain any potential fire or toxic emissions. In some preferred embodiments, the container may be configured to encase an electric vehicle, such as a car. The positioning of the container 102 may involve careful placement to ensure complete coverage of the battery or device. This step may be crucial for creating a controlled environment for fire suppression. The container 102 may be made of materials resistant to high temperatures and corrosive substances, such as nickel alloys or specialized stainless steel. Its design may incorporate features like reinforced seals or gaskets to prevent the escape of gases or flames. In some cases, the container 102 may be equipped with a mechanism for easy deployment, such as a folding structure or a mechanical arm for quick positioning. The size and shape of the container 102 may vary depending on the specific application, ranging from small enclosures for portable devices to large structures capable of containing entire vehicles. In some implementations, the container 102 may have additional features like internal supports or compartments to securely hold the battery or device in place during fire suppression activities. The positioning step may also involve ensuring proper alignment of the container's built-in components, such as sensors, nozzles, and viewing windows, to maximize their effectiveness in monitoring and addressing potential fire situations. In cases where the container 102 is designed for vehicle applications, it may need to be integrated with the vehicle's existing structure, potentially requiring modifications to the vehicle frame or body to accommodate the fire suppression system. The positioning of the container 102 may also take into account factors such as accessibility for maintenance, ease of agent replenishment, and compatibility with surrounding equipment or infrastructure.

Once in place, the at least one sensor 110 may continuously monitor for indicators of a lithium-ion battery fire-such as elevated temperatures or the presence of specific chemical compounds-during step 615. The at least one sensor 110 may send this data to the processor of the computing device 108. During step 620, the processor may perform a query to determine if a lithium-ion battery fire is detected based on the sensor data. If the processor determines that a lithium-ion battery fire is not present, the method may return to step 615. If the processor determines that a lithium-ion battery fire is present, it may proceed to step 625. During step 625, the processor may send a computer readable signal to initiate the fire suppression sequence. Upon initiating the fire suppression sequence, the canisters 104A, 104B, and 104C may discharge their contents during step 630. The fire suppression sequence may involve a carefully orchestrated release of extinguishing agents from the canisters 104A, 104B, and 104C. In a preferred embodiment, the first canister 104A, which in some cases may be a halogen source such as aqueous bromine, may release its agent first. After a predetermined interval, which may be programmed into the computing device 108 and/or determined by the processor based on the data provided by the at least one sensor, the second canister 104B may discharge its contents, which may be a carbon source, such as chloroform or bromotrifluoromethane. These agents may react with the hydrogen fluoride produced by the fire to generate fire-suppressing organohalogens. The third canister 104C may then release a clean-up agent to neutralize any remaining hazardous substances. This sequential release may be designed to maximize the effectiveness of each agent and minimize potential adverse reactions between them. Once the canisters have discharged their contents in the manner directed via the computer readable signal, the processor may proceed to the terminate method step 635.

Throughout this process, the viewing window 114 may allow for visual monitoring of the fire suppression progress without compromising the containment provided by the container 102. In some implementations, the computing device 108 may alert a user who can make the decision to activate the system or modify the fire suppression sequence based on visual observations through the viewing window 114. The computing device 108 may also continuously analyze data from the sensor 110 during the fire suppression sequence, potentially adjusting the timing or quantity of agent release based on real-time conditions within the container 102. This adaptive approach may help ensure optimal use of the extinguishing agents and improve the overall effectiveness of the fire suppression system. The computing device 108 may also alert a user who can make decisions to modify the fire suppression sequence based on visual observations through the viewing window 114. In some cases, the nozzles 116A, 116B, and 116C may be adjustable, allowing for controlled distribution patterns of the extinguishing agents to target specific areas of the fire.

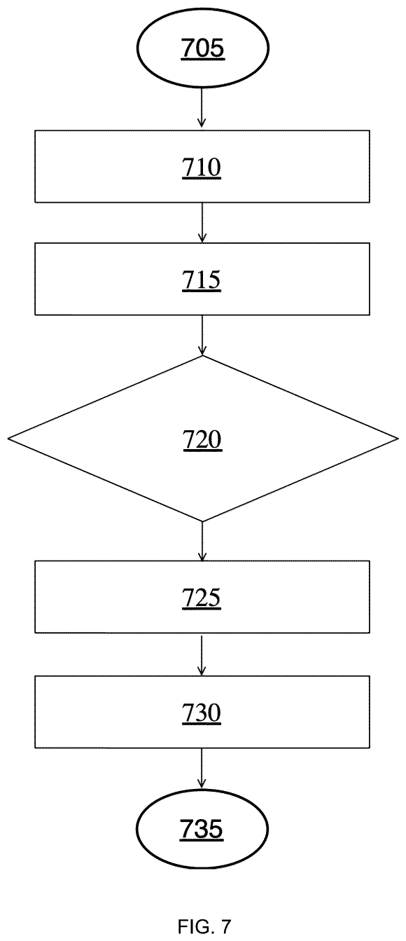

FIG. 7 is a flow diagram 700 illustrating a method for using an integrated fire extinguishing system to extinguish a Lithium-ion battery fire in a vehicle. Step 705 begins the method. During step 710, the integrated fire extinguishing system may be incorporated into a vehicle having a lithium-ion battery. In one preferred embodiment, the integrated fire extinguishing system may be incorporated into the vehicle during manufacture, with the battery pack potentially encased or surrounded by components of the extinguishing system. This integration may help contain any fire and substances produced by the system. In step 715, the at least one sensor 110 may continuously monitor for indicators of a lithium-ion battery fire within the vehicle. The at least one sensor 110 may send this data to the processor operably connected to the at least one sensor, wherein said processor may be integrated into the vehicle in a way to only monitor for fires or may be integrated into the vehicle in a way that allows said processor to manage a plurality of features of the vehicle. During step 720, the processor may perform a query to determine if a lithium-ion battery fire is detected based on the sensor data. If the processor determines that a lithium-ion battery fire is not present, the method may return to step 715. If the processor determines that a lithium-ion battery fire is present, it may proceed to step 725.

During step 725, the processor may send a computer readable signal to initiate the fire suppression sequence. Upon initiating the fire suppression sequence, the canisters 104A, 104B, and 104C may discharge their contents during step 730. The fire suppression sequence may involve a coordinated release of extinguishing agents from the canisters 104A, 104B, and 104C. In some respects, the first canister 104A, which may contain a halogen source such as aqueous bromine, may release its contents into and/or around the battery pack of the vehicle. After a predetermined interval, which may be programmed into the computing device 108 and/or determined by the processor based on the data provided by the at least one sensor, the second canister 104B may discharge its contents, which may be a carbon source, into and/or around the battery pack of the vehicle. The carbon source may react with the hydrogen fluoride produced by the fire to generate fire-suppressing organohalogens. The third canister 104C may then release a clean-up agent to neutralize any remaining hazardous substances. Once the canisters have discharged their contents in the manner directed via the computer readable signal, the processor may proceed to the terminate method step 735.

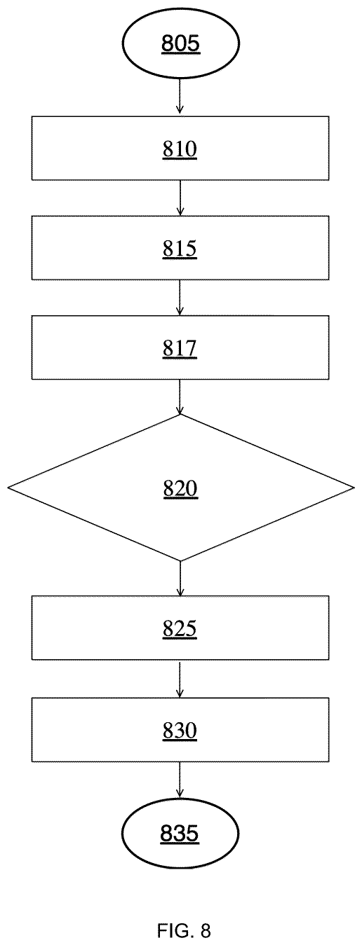

FIG. 8 is a flow diagram 800 illustrating a method for using a system comprising a fireproof blanket to extinguish a Lithium-ion battery fire. Step 605 begins the method. In step 610, a user may position the fireproof blanket over a Lithium-ion battery that has caught fire or is at risk of igniting. In step 615, sensors within the blanket may continuously monitor for indicators of fire, such as elevated temperatures or the presence of specific chemical compounds. The sensors may send data to a processor integrated into the blanket during step 617. In step 620, the processor may perform a query to determine if a Lithium-ion battery fire is present. If no fire is detected, the method may return to step 615 for continued monitoring. If a fire is detected, the processor may proceed to step 625, wherein the fire suppression sequence is initiated. This may involve sending signals to trigger the discharge of extinguishing agents from the canisters. In step 630, the canisters may release their contents in a predetermined sequence. The method may conclude with terminate method step 635 once the fire suppression sequence is complete.

The implementations set forth in the foregoing description do not represent all implementations consistent with the subject matter described herein but are examples consistent with the disclosed subject matter. Although variations have been described in detail above, other modifications or additions may be possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, materials, and arrangements of the parts and method stages which have been described and illustrated in order to explain the nature of this inventive subject matter may be made without departing from the principles and scope of the present disclosure.

1. A fire extinguishing system for lithium-ion battery fires, comprising:
a container configured to enclose a lithium-ion battery;
at least two canisters mounted on the container, each canister containing an extinguishing agent;
at least one sensor configured to detect indicators of a lithium-ion battery fire; and
a computing device operatively connected to the at least two canisters and the at least one sensor,
wherein the computing device is configured to trigger discharge of the extinguishing agents from the canisters based on signals from the at least one sensor.

2. The fire extinguishing system of claim 1, wherein the container is composed of a corrosion-resistant material.

3. The fire extinguishing system of claim 2, wherein the corrosion-resistant material comprises a nickel alloy.

4. The fire extinguishing system of claim 1, wherein the extinguishing agent in at least one of the canisters comprises a carbon source and a halogen source.

5. The fire extinguishing system of claim 4, wherein the carbon source comprises chloroform and the halogen source comprises bromine.

6. The fire extinguishing system of claim 1, further comprising at least one nozzle connected to each canister for dispersing the extinguishing agent.

7. The fire extinguishing system of claim 6, wherein the at least one nozzle is adjustable to control the distribution pattern of the extinguishing agent.

8. A method for extinguishing a lithium-ion battery fire, comprising:
enclosing a lithium-ion battery within a container;
detecting indicators of a lithium-ion battery fire using at least one sensor; and
discharging at least two extinguishing agents into the container in response to the detected indicators, wherein at least one of the extinguishing agents comprises a carbon source and at least one of the extinguishing agents comprises a halogen source.

9. The method of claim 8, wherein the carbon source comprises chloroform and the halogen source comprises bromine.

10. The method of claim 8, further comprising discharging a clean-up agent into the container after the lithium-ion battery fire is suppressed.

11. The method of claim 10, wherein the clean-up agent comprises at least one of activated carbon, powdered graphite, calcium bicarbonate, and sodium bicarbonate.

12. The method of claim 8, wherein detecting indicators of a lithium-ion battery fire comprises detecting at least one of elevated temperature, presence of fluorine, and presence of hydrogen fluoride.

13. The method of claim 8, wherein discharging the at least two extinguishing agents comprises discharging the agents in a predetermined sequence.

14. The method of claim 13, wherein the predetermined sequence comprises discharging the halogen source before discharging the carbon source.

15. A vehicle fire suppression system, comprising:
a vehicle frame supporting a lithium-ion battery;
at least two canisters mounted proximate to the lithium-ion battery, each canister containing an extinguishing agent;
at least one sensor configured to detect indicators of a lithium-ion battery fire; and
a computing device operatively connected to the at least two canisters and the at least one sensor,
wherein the computing device is configured to trigger discharge of the extinguishing agents from the canisters based on signals from the at least one sensor.

16. The vehicle fire suppression system of claim 15, wherein the extinguishing agent in at least one of the canisters comprises a carbon source and a halogen source.

17. The vehicle fire suppression system of claim 16, wherein the carbon source comprises chloroform and the halogen source comprises bromine.

18. The vehicle fire suppression system of claim 15, further comprising at least one nozzle connected to each canister for dispersing the extinguishing agent.

19. The vehicle fire suppression system of claim 18, wherein the at least one nozzle is adjustable to control the distribution pattern of the extinguishing agent.

20. The vehicle fire suppression system of claim 19, wherein the computing device is configured to control the adjustment of the at least one nozzle based on the signals from the at least one sensor.
